(19) United States
(12) Patent Application Publication
(10) Pub. No.: US 2012/0267930 A1
(43) Pub. Date: Oct. 25, 2012

(54) SEATING APPARATUS ADJUSTMENT SYSTEM

(75) Inventors: Anurag Sharda, Westerville, OH (US); Andrew Schultz, Reynoldsburg, OH (US)

(73) Assignee: CVG Management Corporation, New Albany, OH (US)

(21) Appl. No.: 13/453,355

(22) Filed: Apr. 23, 2012

Related U.S. Application Data
(60) Provisional application No. 61/478,456, filed on Apr. 22, 2011.

(51) Int. Cl. B60N 2/12; B60N 2/08

(52) U.S. Cl. 297/313; 297/311

(57) ABSTRACT

A seat adjustment system for a seat assembly in a vehicle is provided and includes a seat locking device attached to a forward suspension rod of the seat assembly, a first seat adjustment mechanism cooperating with the seat locking device to facilitate a sliding motion of a seat assembly, and a second seat adjustment mechanism cooperating with the seat locking device to facilitate a pivoting motion of the seat assembly.

### CROSS-REFERENCE TO RELATED APPLICATIONS

This application claims the benefit of U.S. Provisional Patent application Ser. No. 61/478,456 entitled SEATING APPARATUS ADJUSTMENT SYSTEM filed on Apr. 22, 2011. The entireties of the above-noted applications are incorporated by reference herein.

### FIELD OF THE INVENTION

The innovation relates to vehicle seats and more particularly to vehicle seating assemblies that enable adjustment of either, or both, the lower (e.g., cushion) and upper (e.g., back) portion of seat assembly.

### BACKGROUND

Conventional seats within long haul trucks and other similar vehicles include many safety and comfort features that enhance an operator's driving experience. For example, “fore-aft” vibration isolation is often incorporated into an operator's seating apparatus to “isolate” or dampen vibrations from being transferred into the operator's body. In addition to comfort, safety is an additional motivation for some seating features. For instance, “fore-aft” vibration has been known to cause premature fatigue when an operator is exposed for prolonged periods of time.

In the United States, many aspects of seat assemblies must comply with the Federal Motor Vehicle Safety Standards (FMVSS). These standards have been developed to help minimize the possibility of the failure of seat and restraint designs by the forces acting on them as a result of a sudden deceleration or vehicle impact. For example, FMVSS 571.207 and 571.210 (37 C.F.R. §§ 571.207 & 571.210 (2008)) currently require a seat and seat belt assembly for many vehicles to withstand forces in excess of 3,000 pounds applied to the shoulder belt and lap belt portions of the seat belt.

Other countries impose their own regulations. More specifically, European countries also have safety requirements for seat and restraint designs in the event of a crash or sudden deceleration. For example, certain regulations permit only a limited amount of deformation of the D-ring of a seat belt assembly under load testing.

Other features commonly incorporated into seating apparatuses include vertical compression dampening, cushions, seat assembly forward slide adjustments, seat back tilt adjustments and the like. Unfortunately, these conventional seat assembly features are limited and do not enhance comfort for or conform to drivers of all shapes and sizes. There is a need in the art for a seat assembly adjustment system that complies with regulations (e.g., FMVSS) and provides comfort and adjustability to accommodate a wider range of driver's size and shape than that of conventional systems.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof comprises a seat adjustment system for a seat assembly in a vehicle that includes a seat locking device attached to a forward suspension rod of the seat assembly, a first seat adjustment mechanism cooperating with the seat locking device to facilitate a sliding motion of a seat assembly, and a second seat adjustment mechanism cooperating with the seat locking device to facilitate a pivoting motion of the seat assembly.

In accordance with another aspect of the innovation, a vehicle seat system is provided that includes a seat assembly having a seat base and a seat frame assembly, a seat locking device, a seat slide mechanism cooperating with the seat locking device to adjust a fore-aft position of the seat assembly, and a seat tilt mechanism cooperating with the seat locking device to adjust a tilt angle of the seat frame assembly with respect to the seat base.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1A is a perspective view of an example seat assembly in accordance with aspects of the innovation.

FIG. 1B is a close-up perspective view of a seat locking device in accordance with aspects of the innovation.

FIG. 2 is a perspective view of an example cushion slide assembly in accordance with aspects of the innovation.

FIG. 3 is a perspective close-up view of the example cushion slide assembly in accordance with aspects of the innovation.

FIG. 4 is a perspective close-up view of a portion of the example cushion slide assembly in accordance with aspects of the innovation.

FIG. 5 is a top close-up view of a portion of the example cushion slide assembly in accordance with aspects of the innovation.

FIG. 6 is a perspective view of an example seat tilt latch assembly in accordance with aspects of the innovation.

FIG. 7 is a top view of the example seat tilt latch assembly in accordance with aspects of the innovation.

FIG. 8 is an example flowchart illustrating a method to operate the example seat tilt assembly of FIG. 6 in accordance with aspects of the innovation.

FIG. 9 is a perspective view of an example pivoting stop assembly in accordance with aspects of the innovation.

FIG. 10 is a rear perspective view of an example pivoting stop assembly in accordance with aspects of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein (e.g., thickness), it is to be understood that the features, functions and benefits of the innovation can employ characteristics that vary from those described herein. These alternatives are to be included within the scope of the innovation and claims appended hereto.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Referring now to the figures, the innovation provides a seating apparatus that includes a system that, in one aspect, allows a seat frame assembly of a seat assembly to tilt in a backward direction or in a forward direction, known as negative tilt, with or without the seat being occupied. For example, the innovation may allow the seat frame assembly of the seat assembly to tilt in the backward direction by approximately 10 degrees and in the forward direction by approximately negative 5 degrees, which covers the 5th percentile female through 98th percentile male. It is to the understood that the tilt range can be modified based on original equipment manufacturer (OEM) requirements. In another example, the innovation provides a pivoting stop assembly to prohibit tilting beyond or outside the tilt range.

In another aspect, the innovation enables a seat cushion assembly positioned on a lower frame portion to slide fore-aft with or without occupant seated. For example, the seat cushion can slide in an approximate range of 0-60 mm. It is to be understood that the range can be changed based on requirement or preference. A release button can be integrated within the seat cushion assembly for ease of removal of cushion for servicing. It is to be understood that the release button can be used on a seat cushion that does not have the fore-aft slide feature. Thus, any combination of features, functions and benefits described herein can exist without departing from the spirit and/or scope of the innovation. Furthermore, the innovation can be retrofitted into most any seating frame. In other words, this feature can utilize existing brackets that were designed for seat tilt mechanism. This can reduce parts, components and complexity of a seat apparatus thereby also requiring less effort to operate.

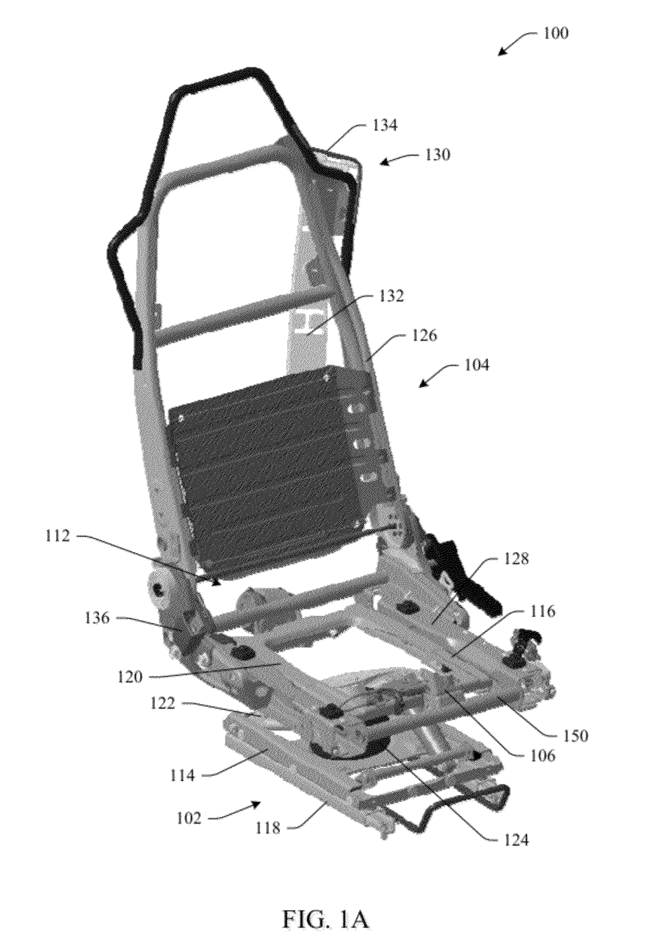

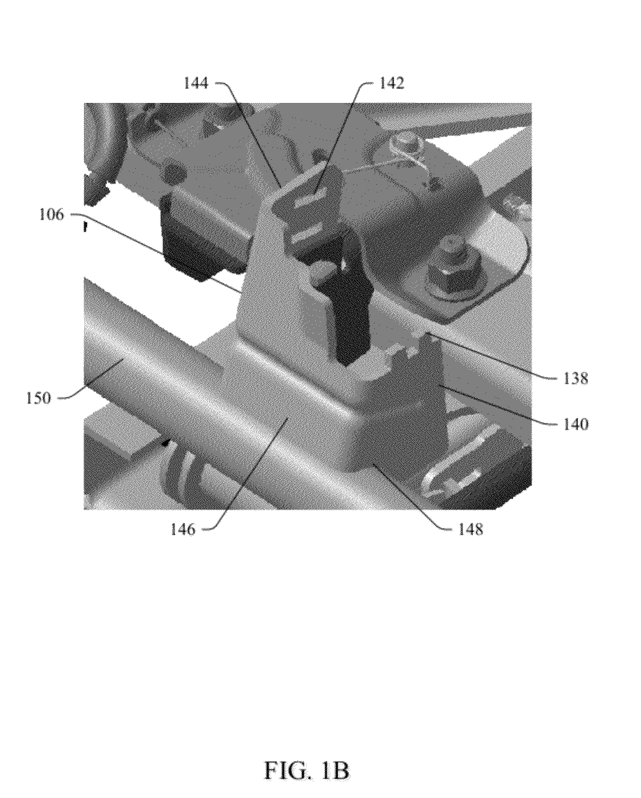

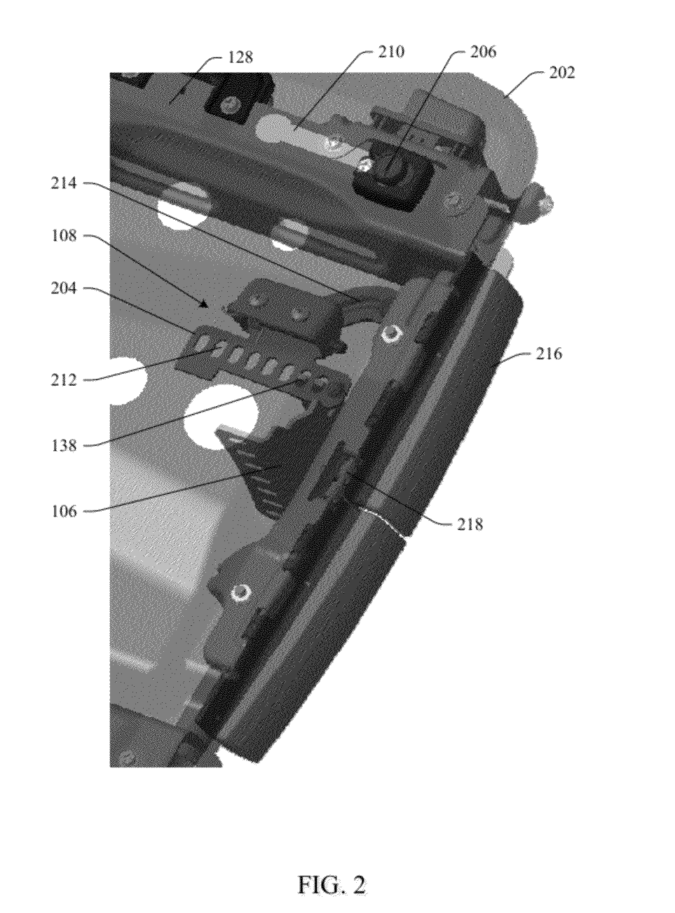

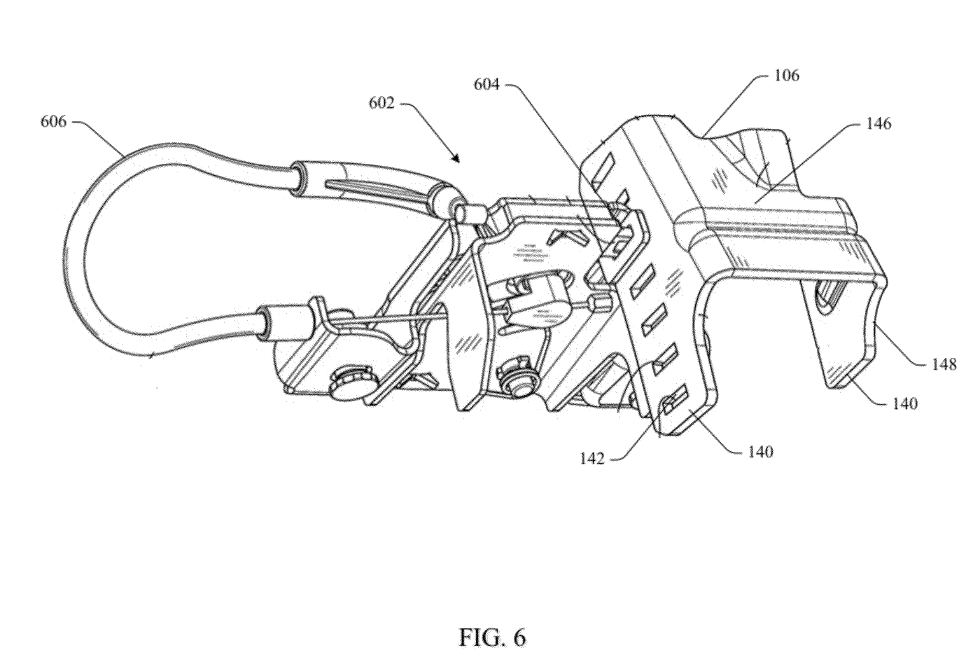

Referring now to FIG. 1, an example seat assembly 100 is shown in accordance with aspects of the innovation. The seat assembly 100 includes a seat base assembly 102, a seat frame assembly 104, and a seat adjustment system. The seat adjustment system is comprised of a seat locking device 106, a seat slide mechanism (first seat adjustment mechanism) 108 (see FIG. 2), and a seat tilt mechanism (second seat adjustment mechanism) 110 (see FIG. 6) that all work in combination to adjust the seat assembly 100 to a desired fore-aft and/or tilt angle position to thereby provide optimum safety and comfort for an occupant. The seat assembly 100 further includes a pivoting stop assembly 112 that cooperates with the seat adjustment system to prevent the seat assembly 100 from pivoting beyond a predetermined range.

The seat base assembly 102 includes a bottom mounting portion 114 and an upper support portion 116. The seat assembly 100 is secured to an interior floor of a vehicle at the bottom mounting portion 114. As shown in FIG. 1, the bottom mounting portion 114 is preferably mounted slidably on rails 118 to allow fore-aft adjustment of the seat assembly 100. The seat base assembly 102 further includes a platform 120 at the upper portion 116 that is connected to the bottom portion 114 by a suspension linkage 122, preferably by a cross-bar or scissors linkage. The seat base assembly 102 is also preferably height adjustable in a vertical direction to accommodate the preferences of an occupant. It is to be appreciated, however, that the seat base assembly 102 can be a static type assembly. The height of the platform 120 is adjustable by controlling the distance between the ends of the bars that make up the scissor linkage 122. The seat may also include an air spring 124 secured between the lower and upper portions 114 and 116 of the seat base 102. It may further include dampers or other conventional dampening and suspension devices.

The seat frame assembly 104 provides support for an occupant and includes an upper backrest frame portion 126 and a lower seat frame portion 128. As shown in FIG. 1, the upper frame 126 provides support for the mid and upper body of a seat occupant. The upper frame portion 126 may include an adjustment mechanism to adjust the angle of inclination of the upper frame 126 with respect to the lower seat frame portion 128.

Still referring to FIG. 1, the seat assembly 100 further includes a seat belt restraint assembly 130. The seat belt restraint assembly 130 includes a restraining belt 132, which is secured to the seat assembly 100 at the upper and lower seat frame portion 126, 128. Specifically, the seat assembly 100 includes a D-ring member 134 mounted to the upper seat frame 126 and a fastening device (e.g., buckle) 136 mounted to the lower seat frame 128. The restraining belt 132 passes through the D-ring member 134 and fastens to the buckle 136 anchored to the lower seat frame 128. Thus, the restraining belt 132 is integrated with the seat assembly 100 and not attached to the interior structure of the vehicle. An integrated restraining belt 132 is typically more comfortable than a restraining belt attached to the vehicle. Further, anchoring the restraining belt 132 to the seat assembly 100 is advantageous because it makes installation of the seat assembly 100 easier, i.e., the seat becomes a complete unit applicable for installation in nearly any vehicle of adequate size. Although one form of seat belt restraint assembly 130 is shown herein, the preferred embodiments of the vehicle seat with pivoting stop mechanism, as described further below, are not dependent on any particular form of seat belt restraint assembly and others may be used.

As mentioned above, the seat adjustment system is comprised of a seat locking device 106, a seat slide mechanism 108, and a seat tilt mechanism 110 that all work in combination to adjust the seat assembly 100 to a desired fore-aft and tilt angle position to thereby provide optimum safety and comfort for an occupant. As shown in the close-up view of the seat locking device 106 in FIG. 1B, the seat locking device 106 includes a plurality of projections 138 extending upward from a first side wall 140 and a plurality of tilt locking slots 142 defined in a second side wall 144. The seat locking device 106 further includes a front wall having 146 having a curved lower portion 148 that engages with a corresponding curved exterior portion of a forward suspension rod 150, which extends between substantially parallel arms of the lower seat frame 128. As will become evident from the description below, the plurality of projections 138 on the locking device 106 cooperate with the seat slide mechanism 108 to facilitate adjusting the seat assembly 100 in a fore-aft direction. Further, the plurality of tilt locking slots 142 defined in the locking device 106 cooperate with the seat tilt mechanism 110 to facilitate adjusting the tilt angle of the seat assembly 100. This arrangement reduces the number of parts of the seat assembly 100, which in turn reduces complexity and cost of the seat assembly 100.

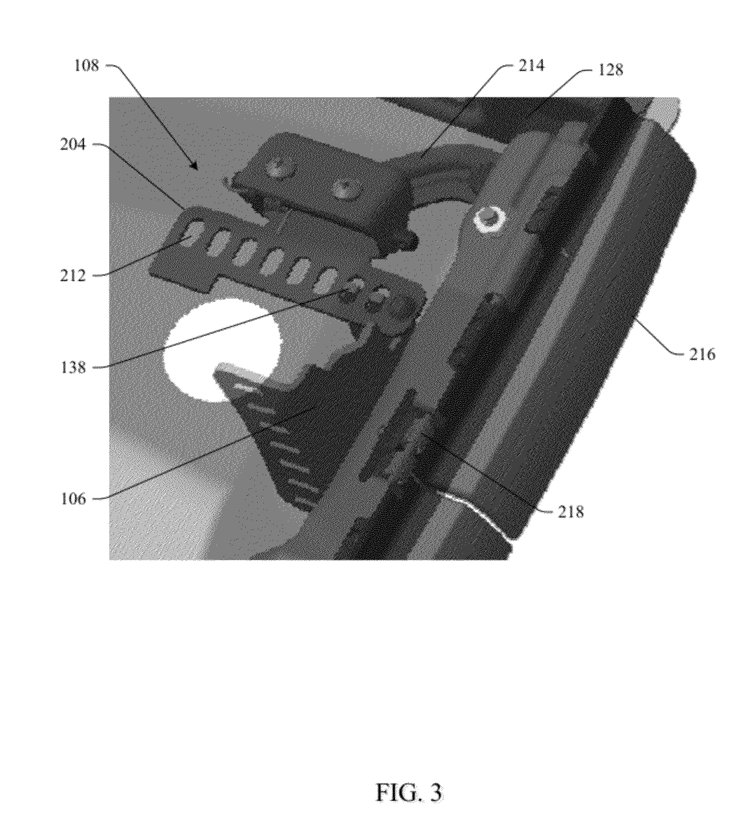

FIGS. 2 and 3 illustrate the example seat slide mechanism 108 in accordance with aspects of the innovation. The seat slide mechanism 108 includes a cushion pan 202, a latching device (cushion latch) 204, and a plurality of slide blocks 206. The latching device 204 is fastened to the cushion pan 202, which is positioned vertically above the lower seat frame 128, by any conventional means, such as but not limited to, bolting, screwing, riveting, etc. The cushion pan 202 is slidably moveable in a fore-aft direction through the operation of the slide blocks 206. The slide blocks 206 are mounted to the lower seat frame 128 and include upper portions that are moveable in the fore-aft direction through slots 210 in the cushion pan 202. The top portion of each slide block 206 has a larger diameter than the intermediate portion to keep each slide block 206 in its position within the corresponding slot 210. The slide blocks 206 permit sliding movement of the cushion pan 202 relative to the lower seat frame 128. In aspects, any number of slide blocks 206 may be used to facilitate sliding of the cushion pan 202. In the example embodiment disclosed herein the number of slide blocks 206 is four.

The latching device 204 is used by the occupant to move the cushion pan 202 to the desired fore-aft position relative to the lower seat frame 128. The latching device 204 includes a plurality of slots 212 defined therein, whereby the plurality of projections 138 engage a subset of the plurality of slots 212 to lock the cushion pan 202 in a desired fore-aft position. The latching device 204 is connected by an actuating arm 214 to a first actuating device (cushion handle) 216. The cushion handle 216 is actuated, either by pushing downward lifting upward, by the occupant to raise or pivot the latching device 204 in an upward direction to disengage the latching device 204 from the plurality of projections 138 located on the seat locking device 106. This action allows the occupant to move the cushion pan 202 in a fore-aft direction to a different desired fore-aft position. The occupant then releases the cushion handle 216 to lower the latching device 204 to allow a different subset of the plurality of slots 212 to interlockably re-engage the plurality of projections 138 on the seat locking device 106 corresponding to the newly-selected fore-aft position. Upon release, the cushion handle 216 is biased back into position by a first biasing means (spring) 218.

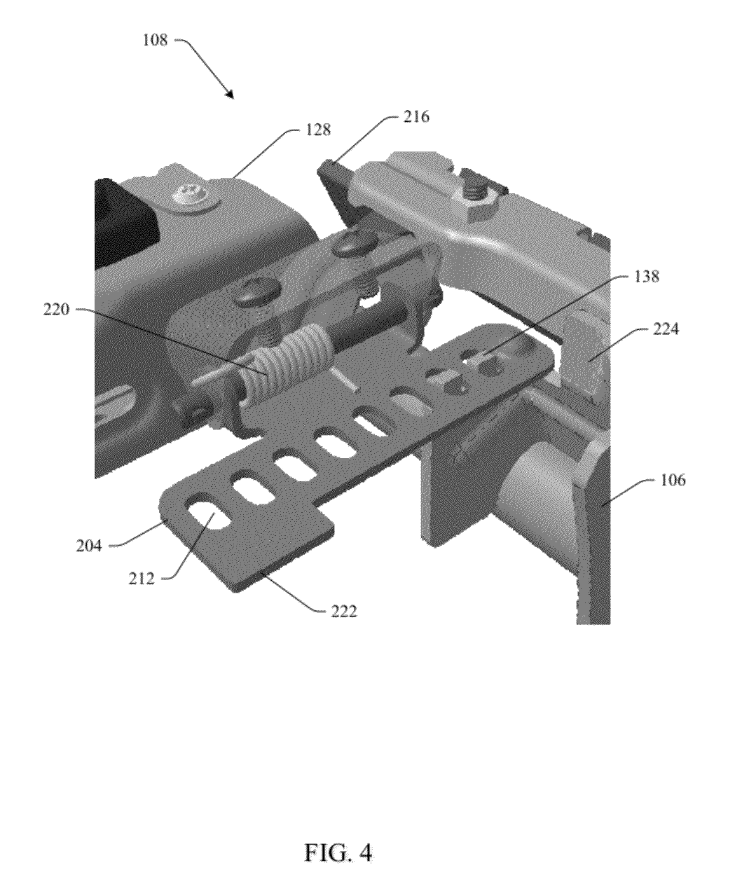

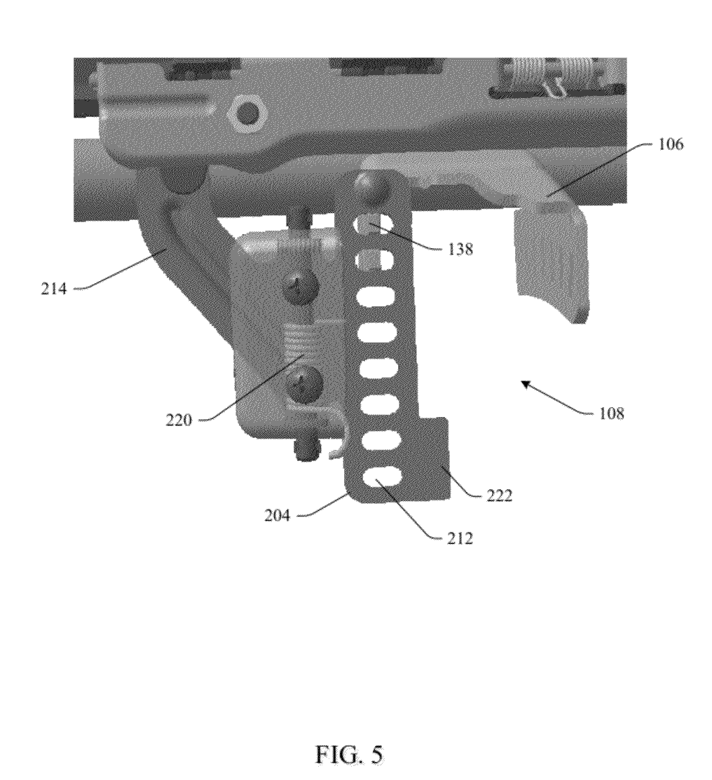

FIGS. 4 and 5 are close-up perspective and top views of the latching device 204 respectively. As mentioned above, the latching device 204 includes a plurality of slots 212 for engagement with the projections on the seat locking device 106 to define various fore-aft positions. The number and size of the plurality of slots 212 may vary based on requirements. In the example embodiment disclosed herein, there are eight slots 212 whereby each slot 212 is approximately 10 mm in width. Thus, in the example embodiment, the cushion pan 202 can slide fore and aft in a predetermined range of approximately 60 millimeters, although this range is easily adjustable by increasing or decreasing the number of slots 212. The seat slide mechanism 108 further includes a second biasing means (spring) 220 that, upon release of the cushion handle 216, biases the latching device 204 back into a locking position, as described above.

As best seen in FIG. 4, the latching device 204 includes a first projection 222 and the seat locking device 106 includes a second projection 224. The first and second projections 222, 224 when cooperating act as a stop when the cushion pan 202 is moved in a furthest most forward position. In other words, when the cushion pan 202 is moved to the furthest most forward position, the first projection 222 engages the second projection 224 thereby limiting a forward movement of the cushion pan 202.

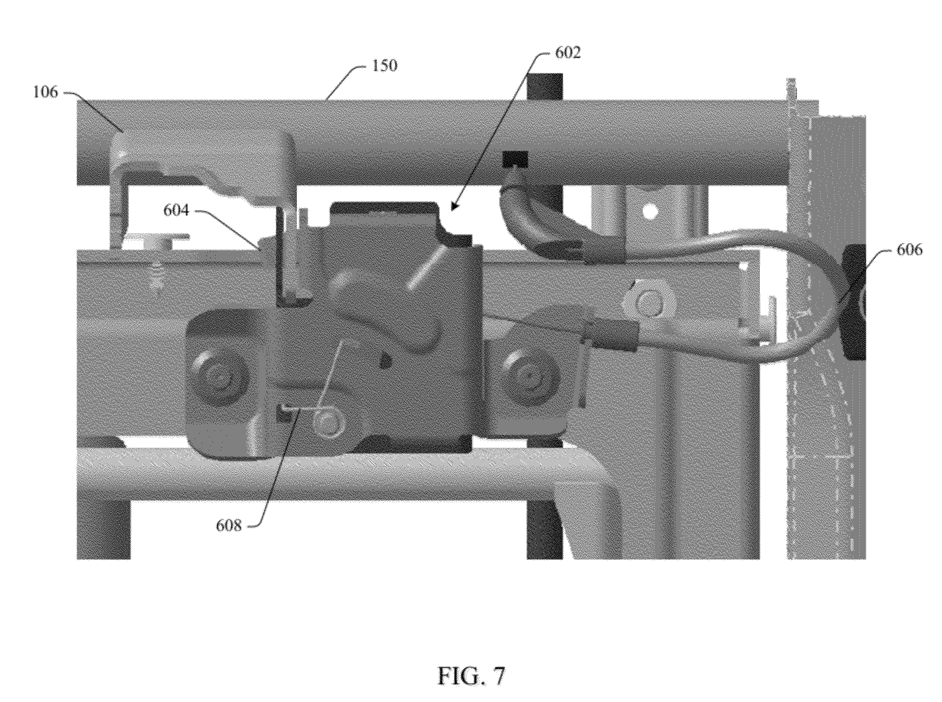

FIGS. 6 and 7 represent illustrations of the seat tilt mechanism 110 in accordance with aspects of the innovation. As mentioned above, the seat tilt mechanism 110 allows the seat frame assembly 104 of the seat assembly 100 to tilt in a backward direction or in a forward direction, known as negative tilt, with or without the seat being occupied.

The seat tilt mechanism 110 includes a seat adjustment device 602 that cooperates with the seat locking device 106 to facilitate a tilt angle adjustment of the seat assembly 100. The seat adjustment device 602 attaches to a top surface of the platform 120, by any conventional fastening means, such as but not limited to bolting, rivets, welds, etc. The seat adjustment device 602 includes a laterally protruding projection 604 that interlockably engages one of the plurality of tilt locking slots 142 in the seat locking device 106. The seat frame assembly 104 may be adjusted to various tilt positions relative to the seat base assembly 102 by vertical movement of the projection 604 into and out of a desired corresponding tilt locking slot 142. The seat adjustment device 602 further includes a second actuating device (cable assembly) 606 that facilitates movement of the projection 604 into and out of the plurality of tilt locking slots 142. In the embodiment illustrated in the figures, a cable assembly serves as the second actuating device 606. It is to be appreciated, however, that other types of actuating devices to operate the seat adjustment device 602 can be incorporated into the innovation. A third biasing means (spring) 608, see FIG. 7, is situated on a side wall of the seat adjustment device 602 and facilitates the engagement and disengagement of the protruding projection 604 with the plurality of tilt locking slots 142.

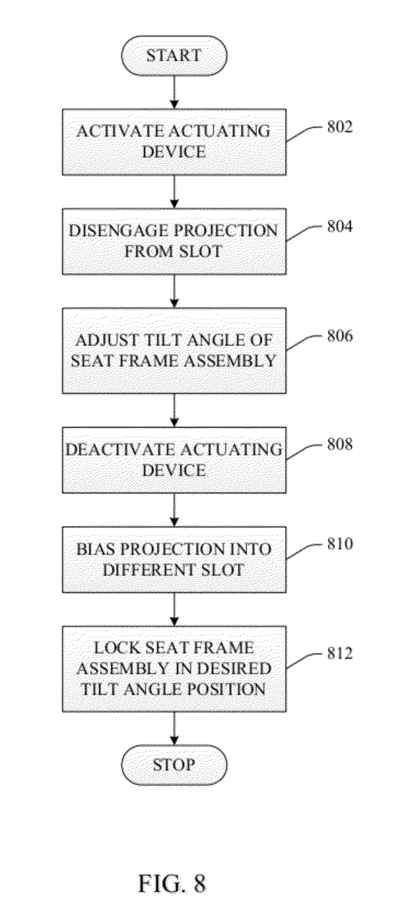

Referring to FIG. 8, to adjust the tilt of the seat frame assembly 104 with respect to the seat base assembly 102, the user simply activates the second actuating device 606 (in this example, the user pulls the cable), at 802 to disengage the protruding projection 604 from one of the plurality of tilt locking slots 142, at 804. At 806, the user adjusts the tilt angle of the seat frame assembly 104 by rotating (or pivoting) the seat frame assembly 104 with respect to the seat base assembly 102. Once the user achieves the desired tilt position, at 808, the user releases the second actuating device 606, whereupon, at 810, the protruding projection 604 is biased into a different tilt locking slot 142, thereby locking, at 812, the seat frame assembly 104 in the desired tilt position.

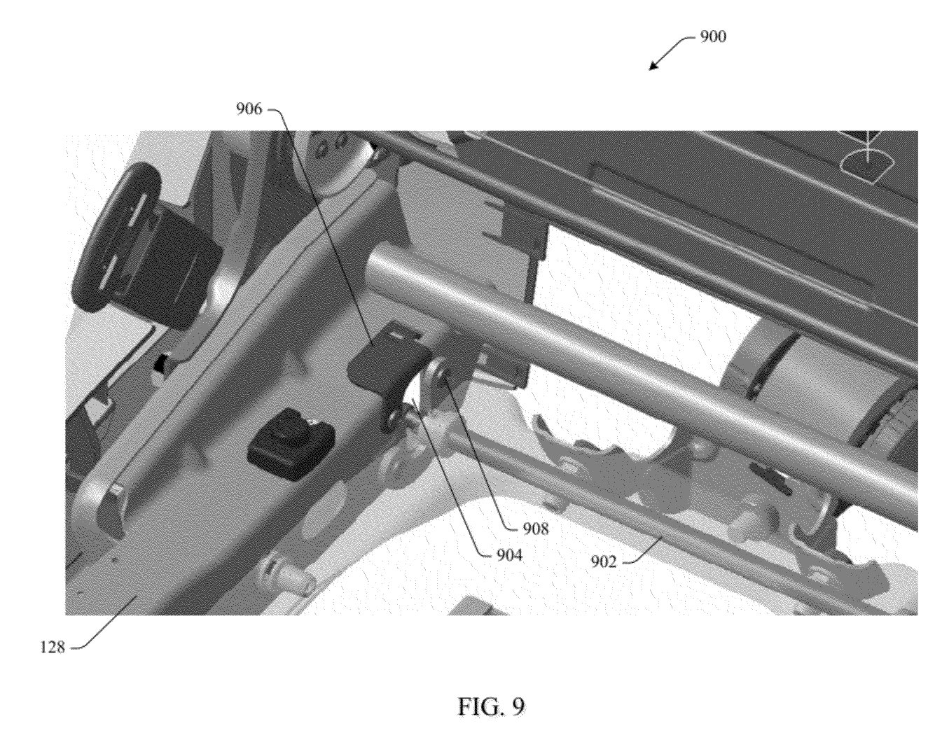

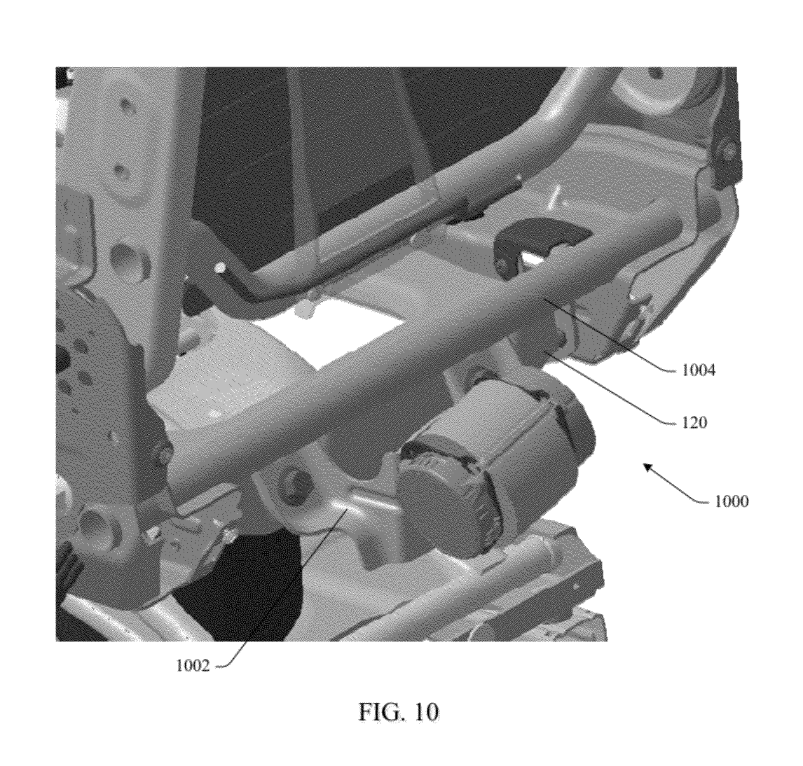

FIGS. 9 and 10 are front and rear perspective views of the pivoting stop assembly 112 respectively in accordance with aspects of the innovation. The pivoting stop assembly 112 includes a first stop pivoting mechanism 900 and a second stop pivoting mechanism 1000. As mentioned above, the pivoting stop assembly 112 prohibits tilting or rotation of the seat assembly 100 beyond or outside a tilt range in the event of a crash.

As shown in FIG. 9, the first stop pivoting mechanism 900 includes a shaft 902, manufactured of most any metal, composite, alloy or other suitably rigid material, that extends into slots 904 defined on each side of the lower seat frame 128, an up-stop bracket 906, and a down stop bracket 908. The up-stop bracket 906 and the down stop bracket 908 are fastened to the lower seat frame 128 by any conventional fastening means, such as but not limited to bolts, screw, rivets, etc. The slots 904 allow pivoting movement of the shaft 902 through a predetermined range. The up-stop bracket 906 and the down stop bracket 908, however, limit the pivoting movement of the seat assembly 100 in a rearward and forward direction respectively beyond the predetermined range. In other words, the shaft 902 engages the up-stop bracket 906 and the down stop bracket 908 in the event that the seat assembly 100 pivots beyond the predetermined range.

As shown in FIG. 10, the second stop pivoting mechanism 1000 prevents the seat assembly 100 from pivoting in a rearward direction beyond a predetermined pivot range. The second stop pivoting mechanism 1000 includes a stop bracket 1002 attached a rear of the platform 120 and a support rod 1004 extending between each side of the lower seat frame 128. In the event that the seat assembly 100 pivots beyond the predetermined pivot range (e.g., in the event of a crash) the support rod 1004 contacts the stop bracket 1002 to thereby prevent further pivoting of the seat assembly 100.

It is to be understood that the pivoting stop assembly 112 works in conjunction with the seat locking device 106 to prevent tilting of the seat frame assembly 104 with respect to the seat base assembly 102 beyond the predetermined tilt range described above.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A seat adjustment system for a seat assembly in a vehicle comprising:
a seat locking device attached to a forward suspension rod of the seat assembly;
a first seat adjustment mechanism cooperating with the seat locking device to facilitate a sliding motion of a seat assembly; and
a second seat adjustment mechanism cooperating with the seat locking device to facilitate a pivoting motion of the seat assembly.

2. The seat adjustment system of claim 1, wherein the seat locking device includes a plurality of projections extending upward from a first side wall, wherein the first seat adjustment mechanism includes a latching device attached to a slidable cushion pan and having a plurality of slots defined therein, and wherein the plurality of projections engage a subset of the plurality of slots to lock the slidable cushion pan in a fore-aft position.

3. The seat adjustment system of claim 2, wherein the first seat adjustment mechanism further includes an actuating device and an actuating arm, and wherein the actuating arm connects the actuating device to the latching device.

4. The seat adjustment system of claim 3, wherein upon actuation of the actuating device, the latching device pivots in an upward direction thereby disengaging the plurality of projections from the subset of plurality of slots to facilitate movement of the cushion pan in the fore-aft direction.

5. The seat adjustment system of claim 4, wherein upon release of the actuation device, the latching device is pivotally biased in a downward direction such that the plurality of projections engage a different subset of the plurality of slots to lock the cushion pan in a different fore-aft position.

6. The seat adjustment system of claim 5, wherein the latching device includes a first projection and the seat locking device includes a second projection, wherein the first projection engages the second projection to limit a forward travel of the cushion pan.

7. The seat adjustment of claim 1, wherein the seat locking device includes a plurality of locking slots defined in a second side wall, wherein the second adjustment mechanism includes a seat adjustment device attached to a top portion of a platform of the seat assembly and having a protruding projection that engages one of the plurality of locking slots to lock the seat assembly at a desired tilt angle.

8. The seat adjustment system of claim 7, wherein the seat adjustment device includes an actuating device to facilitate the engagement and disengagement of the protruding projection with the one of the plurality of locking slots.

9. The seat adjustment system of claim 8, wherein upon actuation of the actuating device, the protruding projection disengages from the one of the plurality of slots to thereby allow pivoting of the seat assembly to adjust a tilt angle of the seat assembly.

10. The seat adjustment system of claim 9, wherein upon release of the actuating device the protruding projection is biased into a different one of the plurality of locking slots to thereby lock the seat assembly at a different tilt angle.

11. The seat adjustment system of claim 10, wherein the actuating device is a cable assembly.

12. A vehicle seat system comprising:
a seat assembly having a seat base and a seat frame assembly;
a seat locking device;
a seat slide mechanism cooperating with the seat locking device to adjust a fore-aft position of the seat assembly; and
a seat tilt mechanism cooperating with the seat locking device to adjust a tilt angle of the seat frame assembly with respect to the seat base.

13. The vehicle seat system of claim 12, wherein the seat locking device includes a plurality of projections extending upward from a first side wall, wherein the seat slide mechanism includes a latching device attached to a slidable cushion pan and having a plurality of slots defined therein, and wherein the plurality of projections engage a subset of the plurality of slots to lock the slidable cushion pan in a fore-aft position.

14. The vehicle seat system of claim 13, wherein the seat slide mechanism further includes an actuating device, wherein upon actuation of the actuating device, the latching device pivots in an upward direction thereby disengaging the plurality of projections from the subset of plurality of slots to facilitate movement of the cushion pan in the fore-aft direction.

15. The vehicle seat system of claim 14, wherein upon release of the actuation device, the latching device is pivotally biased in a downward direction such that the plurality of projections engage a different subset of the plurality of slots to lock the cushion pan in a different fore-aft position.

16. The vehicle seat system of claim 12, wherein the seat locking device includes a plurality of locking slots defined in a second side wall, and wherein the seat tilt mechanism includes a seat adjustment device attached to a top portion of a platform of the seat assembly and having laterally a protruding projection that engages one of the plurality of locking slots to lock the seat assembly at a desired tilt angle.

17. The vehicle seat system of claim 16, wherein the seat adjustment device includes a cable assembly, wherein upon actuation of the cable assembly, the protruding projection disengages from the one of the plurality of slots to thereby allow pivoting of the seat frame assembly with respect to the seat base to adjust a tilt angle of the seat frame assembly.

18. The vehicle seat system of claim 17, wherein upon release of the cable assembly, the protruding projection is biased into a different one of the plurality of locking slots to thereby lock the seat frame assembly at a different tilt angle.

19. A method of adjusting a tilt angle of a seat assembly comprising:
activating an actuation device on a seat adjusting mechanism;
disengaging a protruding projection on the seat adjusting mechanism from one of a plurality of slots in a seat locking device;
adjusting a tilt angle of a seat frame assembly with respect to a seat base of the seat assembly;
releasing the actuation device;
biasing the protruding projection in a different one of the plurality of locking slots; and
locking the seat frame in a different tilt angle.

20. The method of claim 19, wherein the actuation device is a cable assembly.
